(19) United States
(12) Patent Application Publication
(10) Pub. No.: US 2006/0016916 A1
(43) Pub. Date: Jan. 26, 2006

(54) Fuel injector provided with a high flexibility plunger

(75) Inventors: Michele Petrone, San Lazzaro Di Savena (IT); Luca Cagnolati, Bologna (IT)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: MAGNETTI MARELLI POWERTRAIN S S.p.A.

(21) Appl. No.: 11/188,096

(22) Filed: Jul. 22, 2005

(30) Foreign Application Priority Data
Jul. 23, 2004 (IT) TO2004A000512

(51) Int. Cl. F02M 47/02; F02M 59/00; B05B 1/30; F02M 61/00

(52) U.S. Cl. 239/533.2; 239/88; 239/585.5

(57) ABSTRACT

A fuel injector provided with an injection jet, an injection valve, which valve comprises a mobile plunger to control the flow of fuel through the injection jet, and an actuator, which is capable of displacing the plunger between a closed position and an open position of the injection valve; the plunger comprises an elongate rod mechanically connected to the actuator and a sealing head capable of engaging in sealing manner with a valve seat of the injection valve; the rod of the plunger is of high flexibility and exhibits a flexibility parameter of between 1 and 2 N/mm².

The present invention relates to a fuel injector.

The following description will make explicit reference, without consequently losing its general nature, to an electromagnetic injector for a direct fuel injection system.

### BACKGROUND OF THE INVENTION

An electromagnetic fuel injector normally comprises a cylindrical tubular body with a central channel which performs the function of a fuel duct and ends with an injection jet controlled by an injection valve operated by an electromagnetic actuator; in particular, the injection valve is provided with a plunger, which is rigidly connected to a mobile armature of the electromagnetic actuator so as to be displaced by the action of the electromagnetic actuator between a closed position and an open position of the injection jet against the action of a spring which tends to hold the plunger in the closed position.

One example of an electromagnetic fuel injector of the above-described type is given in U.S. Pat. No. 6,027,050-A1, which relates to a fuel injector provided with a plunger which at one end cooperates with a valve seat and at the opposite end is integral with a mobile armature of an electromagnetic actuator; the plunger is guided at the top by the armature and is guided at the bottom by sliding of the end portion of the plunger in a guide portion of the valve seat.

When the plunger is guided at the bottom by the valve seat, the dimensions and positioning of the plunger, of the valve seat and of the armature must be very accurate. Indeed, if structural tolerances are relatively large, when the armature strikes against a fixed armature of the electromagnet, transverse forces may arise which are transmitted to the plunger and are in part dissipated at the level of the coupling between the end portion of the plunger and the guide portion of the valve seat; it has been observed experimentally that if such forces exceed a certain value, localised wear phenomena may occur on the plunger and/or the guide portion of the valve seat with a consequent reduction in the service life of the injector.

As stated above, in order to keep such transverse forces at acceptable levels, the plunger and the guide parts of the plunger must be manufactured to very fine tolerances which accordingly involves complex and costly processing.

### SUMMARY OF THE INVENTION

The object of the present invention is to provide a fuel injector which does not exhibit the above-stated disadvantages and, in particular, is simple and economic to produce.

The present invention provides a fuel injector as specified in the attached claims.

### BRIEF DESCRIPTION OF THE DRAWINGS

The present invention will now be described with reference to the attached drawings, which illustrate some non-limiting embodiments of the invention, in which:

FIG. 1 is a diagrammatic, partially sectional, side view of a fuel injector produced according to the present invention;

FIG. 2 shows an enlarged view of an injection valve of the injector of FIG. 1;

FIG. 3 shows an enlarged view of a mobile armature of the injector of FIG. 1;

FIG. 4 shows another embodiment of the mobile armature of FIG. 3;

FIG. 5 shows an enlarged view of a plunger of the injector of FIG. 1; and

FIG. 6 shows another embodiment of the plunger of FIG. 5.

### DETAILED DESCRIPTION OF THE INVENTION

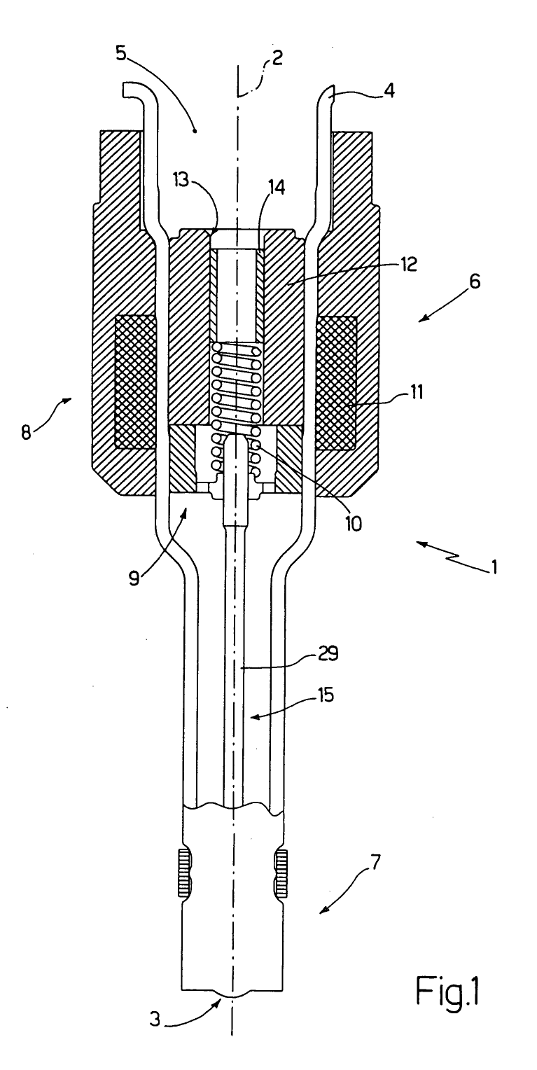

In FIG. 1, 1 denotes the overall fuel injector, which exhibits a substantially cylindrical symmetry around a longitudinal axis 2 and is capable of being operated to inject fuel from an injection jet 3 which opens directly into an explosion chamber (not shown) of a cylinder. The injector 1 comprises a supporting body 4, which has a tubular cylindrical shape of variable cross-section along the longitudinal axis 2 and comprises a supply channel 5 extending along the entire length of said supporting body 4 to supply the pressurised fuel to the injection jet 3. The supporting body 4 accommodates an electromagnetic actuator 6 at the level of an upper portion thereof and an injection valve 7 at the level of a lower portion thereof; in service, the injection valve 7 is actuated by the electromagnetic actuator 6 to control the flow of fuel through the injection jet 3, which is provided at the level of said injection valve 7.

The electromagnetic actuator 6 comprises an electromagnet 8, which is accommodated in fixed position within the supporting body 4 and which, when energised, is capable of displacing a mobile armature 9 of ferromagnetic material along the axis 2 from a closed position to an open position of the injection valve 7 against the action of a spring 10 which tends to hold the mobile armature 9 in the closed position of the injection valve 7. In particular, the electromagnet 8 comprises a coil 11, which is supplied with electricity by an electronic control unit (not shown) and is accommodated outside the supporting body 4, and a fixed magnetic armature 12, which is accommodated inside the supporting body 4 and has a central hole 13 to allow the fuel to flow towards the injection jet 3.

Inside the central hole 13 of the fixed magnetic armature 12, an abutment member 14 is driven into a fixed position, which abutment member is of a tubular cylindrical shape (optionally open along a generating line) to allow the fuel to flow towards the injection jet 3 and is capable of holding the spring 10 in a compressed state against the mobile armature 9.

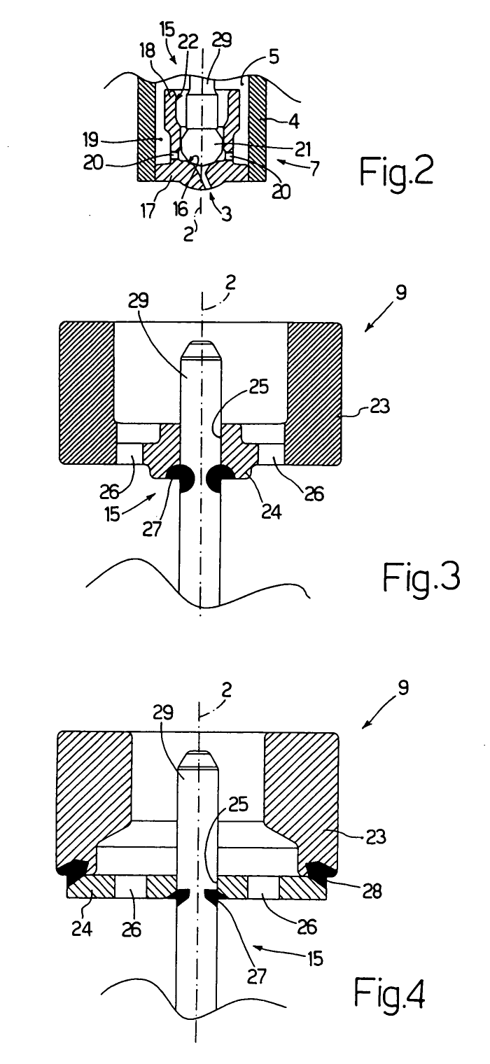

The mobile armature 9 is part of a mobile assembly which moreover comprises a poppet or plunger 15 having an upper portion integral with the mobile armature 9 and a lower portion which cooperates with a valve seat 16 (shown in FIG. 2) of the injection valve 7 to control the flow of fuel through the injection jet 3 in known manner.

As shown in FIG. 2, the valve seat 16 is defined by a sealing member 17, which is disc-shaped, seals the bottom of the supply channel 5 of the supporting body 4, and is passed through by the injection jet 3. A guide member 18 rises up from the discoid sealing member 17, which guide member is tubular in shape, receives within it the plunger 15 to define a lower guide for said plunger 15 and has an external diameter smaller than the internal diameter of the supply channel 5 of the supporting body 4, so as to define an external annular channel 19 through which the pressurised fuel can flow. According to an alternative which is not shown, the guide member 18 has an external diameter which is equal to the internal diameter of the supply channel 5 and has flattened portions on the outside so as to create passages for the fuel.

In the lower part of the guide member 18, there are provided four through-holes 20 (only two of which are shown in FIG. 2), which are arranged perpendicularly to the longitudinal axis 2 and open into the valve seat 16 to allow the pressurised fuel to flow towards said valve seat 16. The through-holes 20 may be arranged offset relative to the longitudinal axis 2 such that they do not converge towards said longitudinal axis 2 and, in service, they impart a swirling flow to the respective streams of fuel.

The plunger 15 ends in a sealing head 21, substantially spherical in shape, which is capable of resting in sealing manner against the valve seat 16. Furthermore, the sealing head 21 rests so as to slide on a cylindrical internal surface 22 of the guide member 18, so that it will be guided as it moves along the longitudinal axis 2.

As shown in FIG. 3, the mobile armature 9 is a monolithic body and comprises an annular member 23 and a discoid member 24, which closes the bottom of the annular member 23 and has a central through-hole 25 capable of receiving an upper portion of the plunger 15 and a plurality of peripheral through-holes 26 (only two of which are shown in FIG. 3) capable of allowing the fuel to flow towards the injection jet 3. A central portion of the discoid member 24 is suitably shaped to receive a lower end of the spring 10 and hold it in position. The plunger 15 is preferably made integral with the discoid member 24 of the mobile armature 9 by means of an annular weld 27.

FIG. 4 shows an alternative embodiment of the mobile armature 9; as shown in FIG. 4, the annular member 23 is distinct from the discoid member 24 and is connected rigidly to said discoid member 24 by means of an annular weld 28.

The annular member 23 of the mobile armature 9 has an external diameter substantially identical to the internal diameter of the corresponding portion of the supply channel 5 of the supporting body 4; in this manner, the mobile armature 9 can slide relative to the supporting body 4 along the longitudinal axis 2, but cannot make any movement transverse to the longitudinal axis 2, relative to the supporting body 4. Since the plunger 15 is rigidly connected to the mobile armature 9, it is clear that the mobile armature 9 also acts as an upper guide for the plunger 15; as a result, the plunger 15 is guided at the top by the mobile armature 9 and at the bottom by the guide member 18.

According to an alternative embodiment which is not shown, an antirebound device is attached to the lower face of the discoid member 24 of the mobile armature 9, which antirebound device is capable of damping the rebound of the sealing head 21 of the plunger 15 against the valve seat 16 when the plunger 15 moves from the open position to the closed position of the injection valve 7.

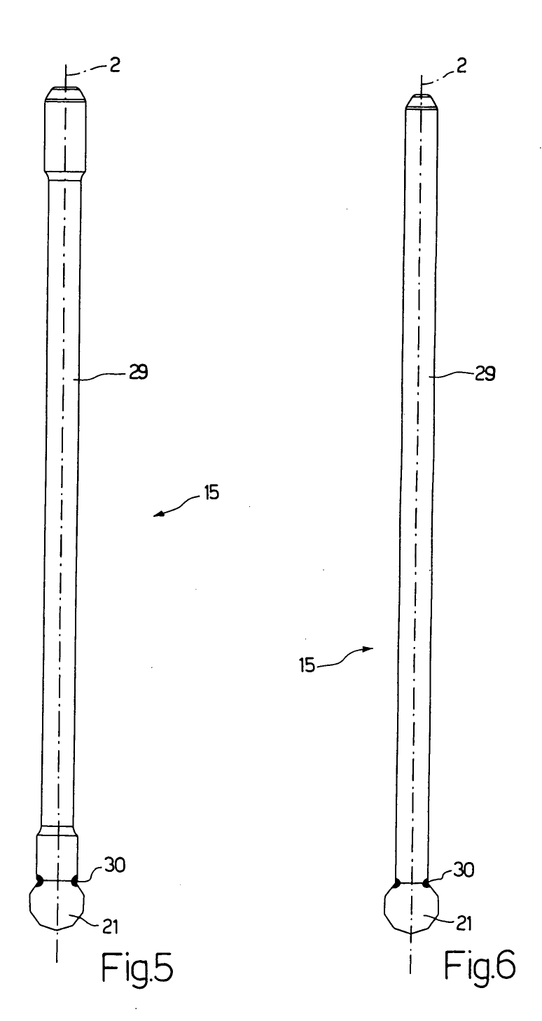

FIG. 5 shows the plunger 15; it can be seen that the plunger 15 has an upper rod 29 with cylindrical symmetry, to which is connected the substantially spherical sealing head 21 by means of an annular weld 30. As shown in FIG. 5, the rod 29 of the plunger 15 is of different diameters along its length; in particular, the end portions of the rod 29 are of a larger diameter relative to the central portion of the rod 29.

According to another embodiment shown in FIG. 6, the rod 29 of the plunger 15 is of a perfectly cylindrical shape with a constant diameter along its entire length. In service, when the electromagnet 8 is de-energised, the mobile armature 9 is not attracted by the fixed magnetic armature 12 and the resilient force of the spring 10 thrusts the mobile armature 9 downwards together with the plunger 15; in this situation, the sealing head 21 of the plunger 15 is pressed against the valve seat 16 of the injection valve 7, so isolating the injection jet 3 from the pressurised fuel. When the electromagnet 8 is energised, the mobile armature 9 is magnetically attracted by the fixed magnetic armature 12 against the resilient force of the spring 10 and the mobile armature 9 moves upwards together with the plunger 15 until it comes into contact with said fixed magnetic armature 12; in this situation, the sealing head 21 of the plunger 15 is lifted relative to the valve seat 16 of the injection valve 7 and the pressurised fuel can flow through the injection jet 3.

When the mobile armature 9 comes to a standstill against the fixed magnetic armature 12, direct longitudinal stresses parallel to the longitudinal axis 2 obviously appear on the mobile armature 9. Due to the inevitable structural tolerances of the various components, the upper surface of the mobile armature 9 may not be perfectly plane and perfectly parallel to the lower surface of the fixed magnetic armature 12 and the plunger 15 may not be perfectly perpendicular relative to the mobile armature 9; consequently, when the mobile armature 9 comes to a standstill against the fixed magnetic armature 12, direct transverse stresses perpendicular to the longitudinal axis 2 may appear on the mobile armature 9. A proportion of such transverse stresses is also transmitted to the plunger 15 and is dissipated at the level of the coupling between the sealing head 21 of the plunger 15 and the guide member 18.

It is necessary to limit the intensity of the stresses which dissipate at the level of the coupling between the sealing head 21 of the plunger 15 and the guide member 18, so as to avoid excessive localised wear phenomena of the sealing head 21. The approach to limiting the intensity of such negative stresses has always been to limit the transverse stresses generated at the level of the mobile armature 9 by means of precision machining of the components in order to obtain very tight structural tolerances. However, it has been observed that it is also possible to use a different approach in order to limit the intensity of such negative stresses, namely instead of limiting the transverse stresses generated at the level of the mobile armature 9, it is possible to limit the transmission of the transverse stresses from the mobile armature 9 to the sealing head 21 of the plunger 15. To this end, it is possible to make the rod 29 of the plunger 15 in such a manner as to impart relatively high flexibility to said rod 29 (or in other words relatively low flexural rigidity) which flexibility is certainly greater than that normally present in known, currently commercially available injectors; it has in fact been observed that increasing the flexibility of the rod 29 reduces the transmission of transverse stresses from the mobile armature 9 to the sealing head 21. In other words, if the rod 29 of the plunger 15 is sufficiently flexible, the transmission of transverse stresses from the mobile armature 9 to the sealing head 21 is reduced and it is then no longer necessary to precision machine the components with the aim of achieving very tight structural tolerances.

It is important to note that the rod 29 of plunger 15 must not be too flexible, because if it were too flexible it would not be capable of ensuring rapid and precise operation of the injection valve 7.

Theoretical analyses and experimental testing have led to the definition of a flexibility parameter P_{f}, which is a reliable indicator of the flexibility of the rod 29 and has the dimensions of a pressure (N/mm²). It is important to note that, since the flexibility parameter P_{f} has the dimensions of a pressure (N/mm²), said flexibility parameter P_{f} may be traced back to the phenomenon of contact/impact pressure wear between the sealing head 21 and the internal surface of the guide member 18.

The flexibility parameter P_{f} is calculated using the following equation:
P_{f}=K_{eq}/Dₕ
in which:

P_{f} [N/mm²] is the flexibility parameter;

Dₕ [mm] is the diameter of the sealing head 21 of the plunger 15;

K_{eq} [N/mm] is the equivalent rigidity of the rod 29 of the plunger 15.

The equivalent rigidity K_{eq} of the rod 29 of the plunger 15 is defined by assuming that the rod 29 is restrained at one end and subjected to a force F at the opposite end such as to inflect the rod 29 by a deflection f at its free end; in the above-stated situation, the equivalent rigidity K_{eq} of the rod 29 is calculated using the following equation:
K_{eq}=F/f
in which:

K_{eq} [N/mm] is the equivalent rigidity of the rod 29 of the plunger 15;

F [N] is the force applied to the free end of the rod 29;

f [mm] is the deflection of the free end of the rod 29.

In the case of a rod 29 of a constant circular cross-section made from a single material, the equivalent rigidity K_{eq} may be calculated using the following equation:
K_{eq}=(E*Dₛ³)/(6.8*Lₛ⁴)
in which:

K_{eq} [N/mm] is the equivalent rigidity of the rod 29 of the plunger 15;

Dₛ [mm] is the diameter of the circular cross-section of the rod 21;

Lₛ [mm] is the length of the rod 21;

E [N/mm²] is the modulus of elasticity of the constituent material of the rod.

In the case of a rod 29 made from a single material and composed of two or more cylindrical sections of different diameters, the equivalent rigidity K_{eq} may be calculated using the following equation:
1/K_{eq}=Σᵢ 1/Kᵢ
in which:

K_{eq} [N/mm] is the equivalent rigidity of the rod 29 of the plunger 15;

Kᵢ [N/mm] is the equivalent rigidity of the i-th cross-section of the rod 29 calculated using the above-stated formula.

In order to achieve the desired effect of limiting the transmission of the transverse stresses from the mobile armature 9 to the sealing head 21 without however prejudicing the performance of the injection valve 7, the flexibility parameter P_{f} must be between 1 and 2 N/mm². The flexibility parameter P_{f} is preferably between 1.3 and 1.5 N/mm² and is substantially equal to approx 1.4 N/mm².

By way of example, in order to obtain a desired value of the flexibility parameter P_{f}, it is possible to use several approaches which are alternatives and/or may be combined with one another in different ways: the transverse section of the rod 29 may be varied, a material of greater or lesser elasticity may be used to produce the rod 29, the cross-sectional shape of the rod 29 may be varied.

1) A fuel injector (1) comprising an injection jet (3), an injection valve (7), which valve is provided with a mobile plunger (15) to control the flow of fuel through the injection jet (3) and an actuator (6), which is capable of displacing the plunger (15) between a closed position and an open position of the injection valve (7); the plunger (15) comprises an elongate rod (29) mechanically connected to the actuator (6) and a sealing head (21) capable of engaging in sealing manner with a valve seat (16) of the injection valve (7); the injector (1) is characterised in that the rod (29) of the plunger (15) is of high flexibility and exhibits a flexibility parameter (P_{f}) of between 1 and 2 N/mm².

2) An injector (1) according to claim 1, wherein the flexibility parameter (P_{f}) is between 1.2 and 1.8 N/mm².

3) An injector (1) according to claim 1, wherein the flexibility parameter (P_{f}) is between 1.3 and 1.5 N/mm².

4) An injector (1) according to claim 1, wherein the flexibility parameter (P_{f}) is around 1.4 N/mm².

5) An injector (1) according to claim 1, wherein the sealing head (21) is substantially spherical in shape.

6) An injector (1) according to claim 5, wherein the flexibility parameter (P_{f}) is calculated using the following equation:
P_{f}=K_{eq}/Dₕ
in which:
P_{f} [N/mm²] is the flexibility parameter;
Dₕ [mm] is the diameter of the sealing head (21);
K_{eq} [N/mm] is the equivalent rigidity of the rod (29).

7) An injector (1) according to claim 6, wherein the equivalent rigidity (K_{eq}) of the rod (29) is defined by assuming that the rod (29) is restrained at one end and subjected to a force (F) at the opposite end such as to inflect the rod (29) by a deflection (f) at its free end; in the above-stated situation, the equivalent rigidity (K_{eq}) of the rod (29) is calculated using the following equation:
K_{eq}=F/f
in which:
K_{eq} [N/mm] is the equivalent rigidity of the rod (29);
F [N] is the force applied to the free end of the rod (29);
f [mm] is the deflection of the free end of the rod (29).

8) An injector (1) according to claim 1, wherein the rod (29) of the plunger (15) has cylindrical symmetry and is of different diameters along its length.

9) An injector (1) according to claim 8, wherein the end portions of the rod (29) are of a larger diameter relative to the central portion of said rod (29).

10) An injector (1) according to claim 1, wherein the rod (29) of the plunger (15) is of a perfectly cylindrical shape with a constant diameter.

11) An injector (1) according to claim 1, wherein the sealing head (21) is rigidly connected to the rod (29) by means of an annular weld (30).

12) An injector (1) according to claim 1, wherein the actuator (6) comprises a spring (10), which tends to hold the plunger (15) in the closed position.

13) An injector (1) according to claim 12, wherein the actuator (6) is an electromagnetic actuator and comprises a coil (11), a fixed magnetic armature (12), and an mobile armature (9), which is magnetically attracted by the magnetic armature (12) against the force of the spring (10) and is mechanically connected to the plunger (15).

14) An injector (1) according to claim 13, wherein the mobile armature (9) is a monolithic body and comprises an annular member (23) and a discoid member (24), which closes the bottom of the annular member (23) and has a central through-hole (25) capable of receiving an upper portion of the plunger (15) and a plurality of peripheral through-holes (26) capable of allowing the fuel to flow towards the injection jet (3).

15) An injector (1) according to claim 13, wherein the mobile armature (9) comprises an annular member (23) and a discoid member (24), which closes the bottom of the annular member (23) and has a central through-hole (25) capable of receiving an upper portion of the plunger (15) and a plurality of peripheral through-holes (26) capable of allowing the fuel to flow towards the injection jet (3); the annular member (23) is rigidly connected to the discoid member (24) by means of an annular weld (28).

16) An injector (1) according to claim 1, wherein the valve seat (16) is defined by a discoid sealing member (17) which is passed through by the injection jet (3); a guide member (18) rises up from the sealing member (17), which guide member is tubular in shape, receives within it the plunger (15) to define a lower guide for said plunger (15) and internally delimits an external annular channel (19) for the pressurised fuel.

17) An injector (1) according to claim 16, wherein, in the lower part of the guide member (18), there are provided four through-holes (20) which open into the valve seat (16) to allow the pressurised fuel to flow towards said valve seat (16).

18) An injector (1) according to claim 17, wherein the through-holes (20) of the guide member (18) are arranged offset relative to a longitudinal axis (2) of the injector (1) such that they do not converge towards said longitudinal axis (2) and, in service, they impart a swirling flow to the respective streams of fuel.
